(19) United States
(12) Patent Application Publication
(10) Pub. No.: US 2011/0179785 A1
(43) Pub. Date: Jul. 28, 2011

(54) POWER PLANT

(75) Inventor: Ulf Sven Ramström, Kalmar (SE)

(73) Assignee: Ulf Sven RAMSTROM, KALMAR (SE)

(21) Appl. No.: 12/997,491

(22) PCT Filed: May 29, 2009
(86) PCT No.: PCT/SE2009/000278

§ 371 Date: Apr. 1, 2011

(30) Foreign Application Priority Data
Jun. 12, 2008 (SE) 0801376-5

(51) Int. Cl. F03B 13/26

(52) U.S. Cl. 60/503

(57) ABSTRACT

The invention relates to a power plant comprising a float (3) arranged to float in a body of water. The float is attached to anchoring means (7) via at least one telescopically extendable leg (5). Flow of a hydraulic medium is generated when the leg is extended or retracted, which activates generation of electrical power in a generator. The power plant is provided with a delay device (13) which controls the flow of hydraulic fluid, such that power generation is evened out. The delay device (13) may control the generation of power such that it compensates for nip and flood tide. The invention further relates to such power plant where the float (3) comprises a cavity for storage of hydraulic fluid in the plant.

The present invention relates to a power plant according to the introductory portions of the independent claims.

In particular, it relates to such a power plant which utilises the tide for power generation.

### BACKGROUND OF THE INVENTION

GB2401405A discloses a tidal power plant with a float and a counterweight that moves up and down with the tide. As the float with counterweight has near neutral buoyancy, it generates a flow of hydraulic fluid both at raising tide and at falling tide. The document discloses a telescopically extendable and retractable leg containing a hydraulic medium that is pumped in and out of the leg. This pumping action is transformed to useable power. The plant does however suffer from the disadvantage that power is generated intermittently, primarily at rising and at falling tides, with no power being generated in between.

DE3128919A1 discloses an other tidal power plant with a float that uses telescopically extendable and retractable legs and hydraulic fluid. The fluid in the leg is in fluid communication with a cavity in the float. The float therefore acts to even out the amount of power generated, as is works as a storage for fluid that may be used over a prolonged period. This action is however passive and may not counteract the influence of varying tide, such as flood tide and nip tide, nor does is compensate for tide varying as a result of varying wind direction and speed.

An object of the invention is therefore to provide a power plant which is able to compensate for varying amplitude in water level fluctuations.

These and other objects are attained by a power plant according to the characterising portion of the independent claim.

### SUMMARY OF THE INVENTION

The invention relates to a power plant comprising a float 3 arranged to float in a body of water. The float is attached to anchoring means 7, anchorable at the floor of the body of water, via at least one telescopically extendable leg 5. Flow of a hydraulic medium is generated when the leg is extended or retracted, which activates generation of electrical power in a generator. The power plant is provided with a delay device 13 which controls the flow of hydraulic fluid, such that power generation is evened out.

In a particularly advantageous embodiment, the delay device 13 controls the generation of power such that it compensates for nip and flood tide.

The invention further relates to such power plant where the float 3 comprises a cavity for storage of hydraulic fluid in the plant.

### BRIEF DESCRIPTION OF THE DRAWINGS

FIG. 1 shows a first embodiment of the invention

FIG. 2 shows a second embodiment of the invention

### DESCRIPTION OF PREFERRED EMBODIMENTS

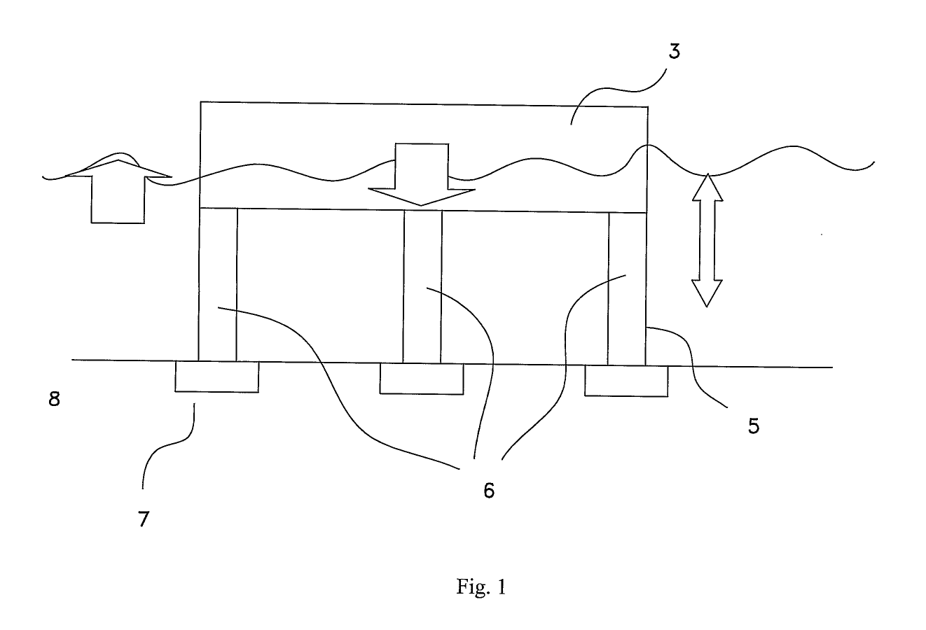

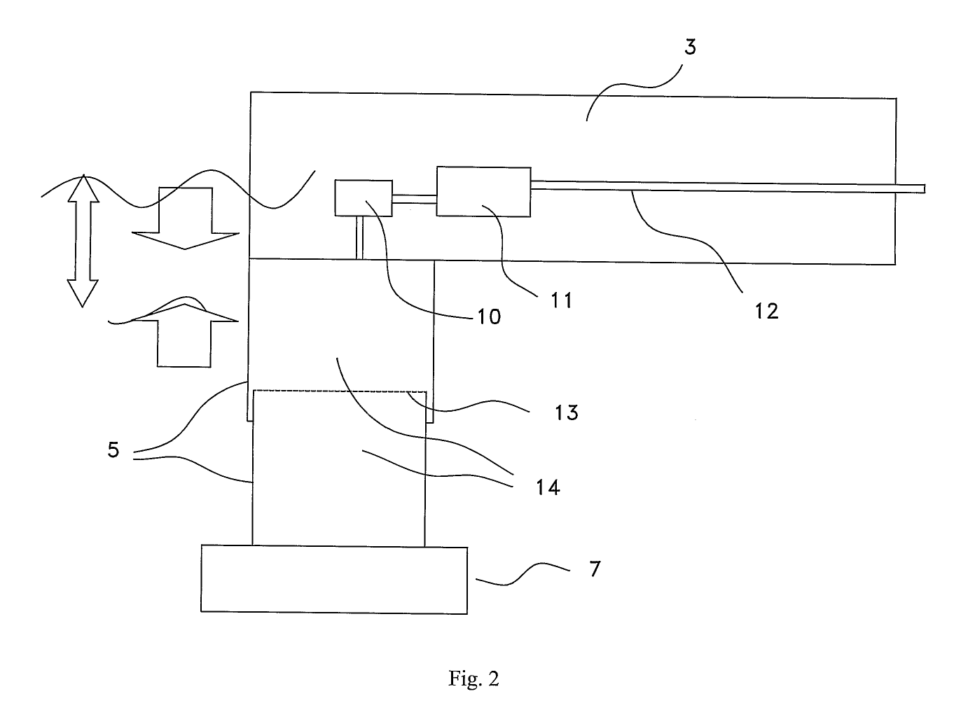

FIG. 1 shows a first embodiment of the invention, comprising a float 3 which may have neutral buoyancy. The float sits in the water submerged to approximately mid height, and is attached to the sea floor 8 with three telescopically extendable legs 5. The legs are fixed to three anchor feet 7 firmly attached to the sea floor. As the tide rises and falls, indicated by the bidirectional arrow, the float rises due to its buoyancy and falls as a result of its weight. The movement of the float is indicated by arrows. This up-and-down movement of the float forces a hydraulic liquid to run through pipes and this power is transferred to electrical power as further detailed in FIG. 2.

FIG. 2 shows a second embodiment of the invention comprising a similar float 3 attached to an anchoring foot 7 on the sea floor via a telescopically extendable leg 5. As indicated by the figure, the horizontal cross sectional area of the float exceeds that of the leg by far, applying large pressure to hydraulic liquid running through the leg, which is advantageous for efficiently utilizing the power exerted by the tide. The leg is hollow and contains hydraulic liquid 14.

The telescopically extendable leg comprises an upper and a lower part which are moveable with respect to each other such that the lower may slide up and down inside the other. The two parts of the leg are sealed by a seal being impermeable to hydraulic fluid. As the leg extends and contracts, hydraulic fluid is forced out of or into the interior of the leg via conduits and is via these conduits in communication with a storage volume held in the float. The running hydraulic fluid passes a hydraulic motor 10 which in turn is mechanically connected to an electric generator 10. The electric generator 10 generates electric power transmitted from the float to a user via an electric conductor 12.

The telescopically extendable leg 5 is provided with delay device 13 symbolically indicated by a dashed line separating the upper and lower parts of the leg. The delay device may in practice be embodied as a valve with a control unit. The valve may, as indicated in the figure, be arranged inside the leg, but may alternatively be arranged in the conduit communicating with the interior of the leg. The valve may switch between fully opened and fully closed, allowing pulse-width-modulation of the average flow through the leg or it may be continuously varied allowing the flow to be continuously varied. The delay device 13 may instead of a valve alternatively be provided by controlling the generator, such that it gives varying resistance to the movement of hydraulic fluid through the system.

The control unit, which is not illustrated, functionally constitutes part of the valve and may be arranged in proximity to the valve although it may be situated elsewhere. It controls the valve in order to achieve a given flow through the system. Had the system lacked such a valve, it would have risen rapidly at rising tide and fallen equally rapidly a falling tide, generating power only intermittently.

The valve is however controlled by the control unit such that the flow of hydraulic fluid is optimized for the given tidal situation, effectively smoothing out the generated over the tidal period. This may be achieved with other means, as is done using prior art tidal power systems, but the valve according to the invention is programmed to take into account varying amplitude of the tide, the extremes of which are nip tide and spring tide. The control unit only needs an internal clock with calendar and a data base of the tide. Using this information it may allow a larger flow through the valve at spring tide, a smaller flow at nip tide and intermediate flows there between to make the power plant produce an optimally even power.

A more advanced version of the control unit may make use of further information, such as wind speed and direction, which affects the tide. Typically, such a control unit works in conjunction with a centralized control node that is able to provide several tide power plants with information input, jointly constituting a control system. In such a group of tidal power plants the individual power plants may be controlled to generate power with a slight delay between different plants, such that the group as a whole generates power without interruptions.

Although the invention has been described in conjunction with a number of preferred embodiments, it is to be understood that various modifications may still be made without departing from the scope of the invention as defined by the appended claims. One such modification is that the electrical power generation obviously, does not need to use a hydraulic motor mechanically connected to an electrical generator, but may instead be embodied as a turbine positioned in the conduits which is mechanically connected to a generator.

1-3. (canceled)

4. A power plant comprising a float arranged to float in a body of water, where the float is attached to anchoring means, anchorable at the floor of said body of water, via at least one hollow telescopically extendable leg, where the interior of the hollow telescopically extendable leg is in communication with a storage volume held in the float via conduits, where flow of a hydraulic medium in these conduits is generated when said leg is extended or retracted, which activates generation of electrical power in a generator, wherein that said power plant is provided with a delay device which controls the flow of hydraulic fluid, where the delay device comprises a controllable valve with a control unit arranged in the path of the flowing hydraulic fluid and a control unit, controlling the flow resistance of the valve unit.

5. A power plant according to claim 4, wherein said delay device controls the generation of power such that it compensates for neap and flood tide.

6. A power plant according to claim 4, wherein said float is adapted to rise due to its buoyancy and fall due to its weight.

7. A power plant according to claim 4, wherein the horizontal cross sectional area of the float exceeds the cross sectional area of the leg.

8. A power plant according to claim 4, wherein said control unit allows larger flow through said valve at spring tide and smaller flow at nip tide.

9. A power plant according to claim 4, wherein said valve is adapted to allow pulse-width modulation of the average flow.

10. A power plant according to claim 4, wherein said valve is adapted to allow continuous variation of the flow.

11. A power plant according to claim 4, wherein said control unit is adapted to work in conjunction with a centralized control node to provide several power plants with information input, jointly constituting a control system.

12. A power plant according to claim 11, wherein in such a group of tidal power plants the individual power plants are controlled to generate power with a delay between different plants, such that the group as a whole generates power without interruptions.

13. A power plant according to claim 5, wherein said float is adapted to rise due to its buoyancy and fall due to its weight.

14. A power plant according to claim 5, wherein the horizontal cross sectional area of the float exceeds the cross sectional area of the leg.

15. A power plant according to claim 6, wherein the horizontal cross sectional area of the float exceeds the cross sectional area of the leg.

16. A power plant according to claim 5, wherein said control unit allows larger flow through said valve at spring tide and smaller flow at nip tide.

17. A power plant according to claim 6, wherein said control unit allows larger flow through said valve at spring tide and smaller flow at nip tide.

18. A power plant according to claim 7, wherein said control unit allows larger flow through said valve at spring tide and smaller flow at nip tide.

19. A power plant according to claim 5, wherein said valve is adapted to allow pulse-width modulation of the average flow.

20. A power plant according to claim 6, wherein said valve is adapted to allow pulse-width modulation of the average flow.

21. A power plant according to claim 7, wherein said valve is adapted to allow pulse-width modulation of the average flow.

22. A power plant according to claim 8, wherein said valve is adapted to allow pulse-width modulation of the average flow.

23. A power plant according to claim 4, wherein said valve is adapted to allow continuous variation of the flow.
